(19) United States
(12) Patent Application Publication
(10) Pub. No.: US 2026/0213152 A1
(43) Pub. Date: Jul. 23, 2026

(54) ELECTRODE SHEET MANUFACTURING APPARATUS AND METHOD

(71) Applicant: SK On Co., Ltd., Seoul (KR)

(72) Inventors: Young Jun KIM, Daejeon (KR); Sung Jun PARK, Daejeon (KR); Hye Won HWANG, Daejeon (KR)

(21) Appl. No.: 19/448,111

(22) Filed: Jan. 14, 2026

(30) Foreign Application Priority Data
Jan. 23, 2025 (KR) 10-2025-0010200

(51) Int. Cl. H01M 4/04; H01M 4/62

(52) U.S. Cl. CPC H01M 4/0435; H01M 4/623

(57) ABSTRACT

An electrode sheet manufacturing apparatus according to an embodiment of the present disclosure may include: a mixing unit mixing powder particle-type mixed powder including an electrode active material to form kneading powder; and a press unit connected to the mixing unit and pressurizing the kneading powder to form an electrode sheet, and the mixing unit may include: a housing including a mixing space; and a screw member disposed in the mixing space and including a plurality of conveying disk members and a plurality of disk kneading members provided with a plurality of unit disk kneading members, and a kneading ratio between a length of the screw member and a length of the plurality of unit disk kneading members is 30% or more and 50% or less.

### CROSS-REFERENCE TO RELATED APPLICATION(S)

This patent document claims the priority and benefits of Korean Patent Application No. 10-2025-0010200 filed on Jan. 23, 2025, the disclosure of which is incorporated herein by reference in its entirety.

### TECHNICAL FIELD

The present disclosure relates to an electrode sheet manufacturing apparatus and method.

### BACKGROUND

Batteries are widely used not only in small electronic devices such as mobile phones and laptop computers, but also in medium- to large-sized mechanical devices such as electric vehicles (EV) and energy storage devices, and offer the advantage of being rechargeable and reusable.

An electrode assembly including a cathode sheet and an anode sheet is housed in a case selected for an intended use thereof, such as a pouch, square, or cylindrical shape, and an electrolyte is supplied to manufacture a battery cell.

A plurality of battery cells may be connected via busbars to form a battery device. Examples of such a battery device include a battery module and/or a battery pack.

In order to manufacture a cathode sheet, a cathode active material, a conductive material, and a binder may be pre-mixed. The pre-mixed cathode powder particles may then be produced, and the pre-mixed cathode powder particles may then be stirred by a mixer or an extruder to manufacture a lump of cathode kneading powder. The pre-mixed cathode powder particles may then be pressed with a roller to manufacture a cathode sheet.

Additionally, an anode mixed powder produced by premixing the anode active material, the conductive material and the binder may be stirred to manufacture a lump of anode kneading powder, which may then be pressed to manufacture an anode sheet.

### SUMMARY

According to an aspect of the present disclosure, an electrode sheet manufacturing apparatus and method having improved mixing efficiency or mixing efficiency of a mixed powder are provided.

According to an aspect of the present disclosure, an electrode sheet and kneading powder having improved quality are provided.

Furthermore, the present disclosure may be widely applied to green technology fields such as solar power generation and wind power generation.

Furthermore, the present disclosure may be applied to eco-friendly devices such as eco-friendly electric vehicles and hybrid vehicles that ameliorate the effects of climate change by suppressing air pollution and greenhouse gas emissions.

An electrode sheet manufacturing apparatus according to an embodiment of the present disclosure may include: a mixing unit mixing a powder particle-type mixed powder including an electrode active material to form kneading powder; and a press unit connected to the mixing unit and pressurizing the kneading powder to form an electrode sheet, and the mixing unit may include: a housing including a mixing space; and a screw member disposed in the mixing space and including a plurality of conveying disk members and a plurality of disk kneading members provided with a plurality of unit disk kneading members, and a kneading ratio between a length of the screw member and a length of the plurality of unit disk kneading members may be 30% or more and 50% or less.

In an embodiment, the screw member may include: a conveying zone in which the plurality of conveying disk members are arranged in a longitudinal direction of the screw member; and a kneading zone which is adjacent to the conveying zone, and in which the conveying disk member and the disk kneading member are alternately disposed, and a length of the screw member may be a sum of a length of the conveying zone and the kneading zone.

In an embodiment, in the screw member, a ratio of the sum of the length of the conveying zone and the length of the kneading zone to a diameter of the conveying disk member may be 27.5 or more and 65 or less.

In an embodiment, a length of at least one of the plurality of unit disk kneading members may be 3 mm or more and 9 mm or less.

In an embodiment, the plurality of disk kneading members may include: a first disk kneading member in which a length of the at least one unit disk kneading member has a first length; and a second disk kneading member in which a length of the at least one unit disk kneading member has a second length.

In an embodiment, the first length may be 3 mm or more and 5 mm or less, and the second length may be 7 mm or more and 9 mm or less.

In an embodiment, at least one conveying disk member of the plurality of conveying disk members may include a spiral edge on an outer surface thereof.

In an embodiment, at least one unit disk kneading member of the plurality of unit disk kneading members may be oval.

In an embodiment, the press unit may include: a plurality of press roll members spaced apart from each other to form a pressurizing gap and configured to rotate.

In an embodiment, the electrode sheet manufacturing apparatus may further include: a rotating portion rotating the screw member.

An electrode sheet manufacturing method according to an embodiment of the present disclosure may include: a premixing operation of mixing powder particle-type electrode active material, a conductive material, and a binder to manufacture a mixed powder; and a mixing operation of stirring the mixed powder with the screw member to manufacture kneading powder.

In an embodiment, the electrode active material may be 96 wt % or more and 98 wt % or less.

In an embodiment, the binder may be polytetrafluoroethylene (PTFE) and may have a value of 2 wt % or more and 4 wt % or less relative to a weight of the mixed powder.

In an embodiment, the conductive material may be 0.3 wt % or more and 0.6 wt % or less.

According to an aspect of the present disclosure, an electrode sheet manufacturing apparatus and method having improved mixing efficiency or mixing efficiency of a mixed powder may be provided.

According to an aspect of the present disclosure, an electrode sheet and kneading powder having improved quality may be provided.

Furthermore, the present disclosure may be widely applied in green technology fields such as solar power generation and wind power generation.

Furthermore, the present disclosure may be applied to eco-friendly devices such as eco-friendly electric vehicles and hybrid vehicles that prevent climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 schematically illustrates an electrode sheet manufacturing apparatus according to an example embodiment of the present disclosure.

FIG. 2 is an image of a mixed powder according to an example embodiment of the present disclosure.

FIG. 3 is an image of kneading powder according to an example embodiment of the present disclosure.

FIG. 4 is a schematic cross-sectional view of a mixing unit according to an example embodiment of the present disclosure.

FIG. 5 is a schematic perspective view of a conveying disk according to an example embodiment of the present disclosure.

FIG. 6 is a schematic perspective view of a kneading disk according to an example embodiment of the present disclosure.

FIG. 7 is a schematic cross-section taken along line IT′ of FIG. 6.

FIG. 8 is a schematic illustration of a screw according to an example embodiment of the present disclosure.

FIG. 9 is a schematic illustration of a screw according to another embodiment of the present disclosure.

FIG. 10 is a schematic illustration of a screw according to another embodiment of the present disclosure.

FIG. 11 schematically illustrates a screw member according to another embodiment of the present disclosure.

FIG. 12 schematically illustrates a press portion according to an embodiment of the present disclosure.

FIG. 13 is a table comparing the tensile strength of electrode sheets manufactured using an electrode sheet manufacturing apparatus and/or method according to embodiments of the present disclosure with the tensile strength of electrode sheets manufactured according to comparative examples.

FIG. 14 is a table illustrating the tensile strength of electrode sheets manufactured using an electrode sheet manufacturing apparatus and/or method according to another embodiment of the present disclosure.

FIG. 15 schematically illustrates an electrode sheet manufacturing method according to an embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Hereinafter, an X-axis illustrated in the drawing is a longitudinal direction of a screw member 114 and may be a transport direction of a mixed powder. A Y-axis and a Z-axis may be a width direction or a diameter direction of the screw such directions member 114. However, are directions arbitrarily set for the convenience of understanding, and the aforementioned directions may be changed and applied.

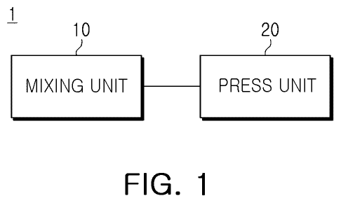

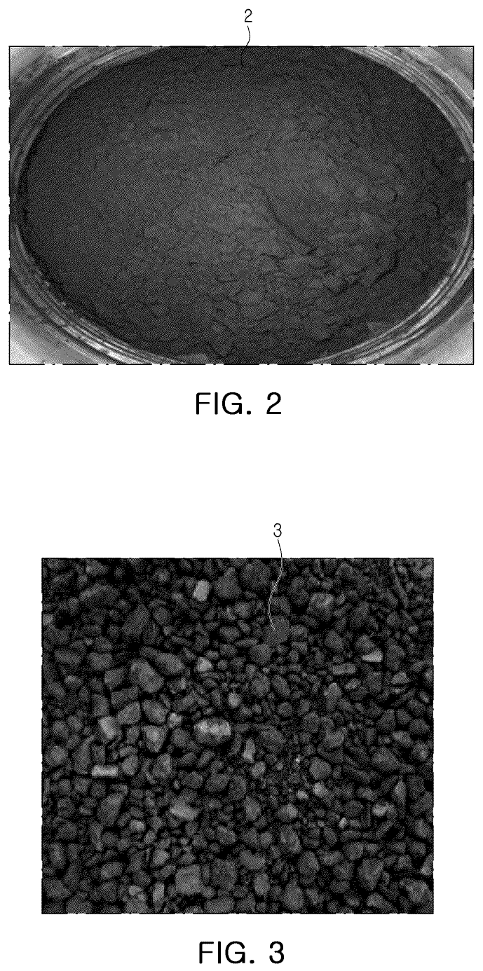

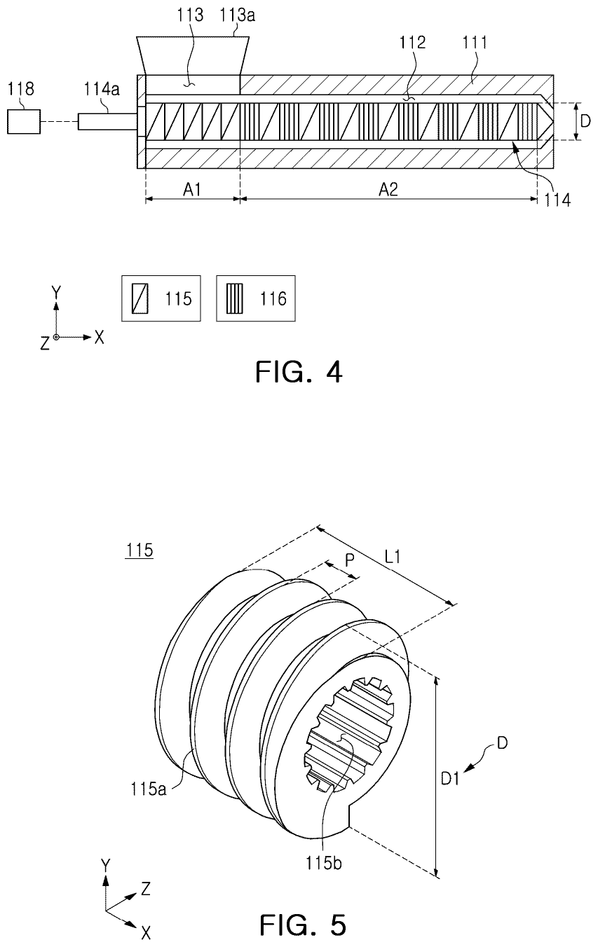

FIG. 1 schematically illustrates an electrode sheet manufacturing apparatus 1 according to an embodiment of the present disclosure, FIG. 2 is an image of a mixed powder 2 according to an embodiment of the present disclosure, FIG. 3 is an image of kneading powder 3 according to an embodiment of the present disclosure, and FIG. 4 is a schematic cross-sectional view of a mixing unit 10 according to an embodiment of the present disclosure.

As illustrated in FIGS. 1 to 4, the electrode sheet manufacturing apparatus 1 according to an embodiment of the present disclosure may include a mixing unit 10 stirring or mixing a powder particle-type mixed powder 2 to form kneading powder 3, and a press unit 20 connected to the mixing unit 10 pressurizing the kneading powder 3 to form an electrode sheet. The electrode sheet may include a cathode sheet and an anode sheet. An electrical polarity of the sheet may be determined by the type of electrode active material included in the mixed powder 2.

The mixing unit 10 and the press unit 20 may be connected to each other by a conveyor belt, a transport rail, a connecting frame, or the like. Alternatively, the kneading powder 3 discharged from the mixing unit 10 may be supplied to the press unit 20 by a robot arm, a gripper, etc. However, a method of supplying the kneading powder 3 is not limited by the present disclosure.

In an embodiment, the mixing unit 10 may include: a mixing space 112, a housing 111 connected to the mixing space 112, a screw member 114 disposed in the mixing space 112 and including a plurality of conveying disk members 115 and a plurality of disk kneading members 116, and a rotating portion 118 rotating the screw member 114.

Additionally, the screw member 114 may include a conveying zone (or a conveying area) A1 in which the plurality of conveying disk members 115 are arranged in a longitudinal direction of the screw member 114, and a kneading zone (or a kneading area) A2 which is adjacent to the conveying zone A1, and in which the conveying disk members 115 and the disk kneading members 116 are alternately disposed.

The housing 111 may include the mixing space 112 therein. The housing 111 may include an inlet 113 connected to the mixing space 112. The housing 111 may include a hopper 113a connected to the inlet 113. A powder or powder particle-type mixed powder 2 may be input into the mixing space 112 through the hopper 113a.

At least a portion of the screw member 114 may be disposed in the mixing space 112. A plurality of conveying disk members 115 and a plurality of disk kneading members 116 may be provided in at least a portion of the screw member 114. The plurality of conveying disk members 115 and the plurality of disk kneading members 116 may be disposed in the mixing space 112.

The screw member 114 may include a drive shaft 114a. In an embodiment, the drive shaft 114a may extend outside the housing 111 and may be connected to a rotating portion 118. The rotating portion 118 may include an actuator. The actuator may include a motor, and the like. However, the type of actuator is not limited by the present disclosure.

A coupling portion between the drive shaft 114a and the housing 111 may be provided with a bearing, or the like. Accordingly, when the drive shaft 114a rotates, the drive shaft 114a may not interfere with the housing 111.

The actuator may provide driving force of rotating the screw member 114. Rotational speed and a rotational direction of the screw member 114 may be adjusted by adjusting a rotational direction and rotational speed of the actuator. The actuator may be manually controlled by an operator or automatically controlled by a controller including a controller, a relay, and the like.

For example, the controller may include at least one of a microcontroller, a microcontroller unit, and a programmable logic controller (PLC).

The screw member 114 may have a conveying zone A1 and a kneading zone A2 in a longitudinal direction (X-direction). The conveying zone A1 may face or correspond to the inlet 113. An electrode mixture supplied from the hopper 113a may be supplied first to the conveying zone A1. The conveying zone A1 may supply the mixed powder 2 to the kneading zone A2.

In an embodiment, the kneading zone A2 may be disposed to conform to the conveying zone A1 in a conveying direction of the mixed powder 2. For example, the kneading zone A2 may be connected to or adjacent to the conveying zone A1, and the kneading zone A2 may be disposed to conform to the conveying zone A1 in an +X-direction. Accordingly, the conveying zone A1 may be disposed in a lower portion of the inlet 113, and the kneading zone A2 may be disposed after the conveying zone A1. Accordingly, the mixed powder 2 input into the inlet 113 may be supplied to the kneading zone A2 via the conveying zone A1.

Then, a material discharged through the kneading zone A2 to the outside of the housing 111 may be a kneading powder 3. The housing 111 may include an outlet for discharging the kneading powder 3, but a method of discharging the kneading powder 3 is not limited by the present disclosure.

An outer surface of the screw member 114 may be spaced apart from an inner surface of the housing 111, and a space formed by separating the outer surface of the screw member 114 from an inner surface of the housing 111 may serve as a mixing space 112. Movement of the mixed powder 2 in the mixing space 112 may be performed by the rotation of the screw member 114. The mixed powder 2 may be disposed in the mixing space 112, and the mixed powder 2 may be moved in the +X-direction within the mixing space 112 by the rotation of the screw member 114.

The mixed powder 2 may be mixed or stirred while moving in the +X-direction within the mixing space 112 and may thus be in the form of the kneading powder 3. For example, the mixed powder 2 may be supplied to the kneading zone A2 via the conveying zone A1, and as the mixed powder 2 passes through the kneading zone A2, the mixed powder 2 may gradually form a lumped kneading powder 3.

The mixed powder 2 may be fibrillated while passing through the kneading zone A2. For example, the mixed powder 2 may include an electrode active material, a binder, a conductive material, and a dispersant. The binder may be polytetrafluoroethylene (PTFE). As the mixed powder 2 passes through the kneading zone A2, the binder may be fibrillated by a certain degree, and particles including in a powder or a powder particle of the mixed powder 2 may be agglomerated with each other, thus increasing a size or a diameter of particles constituting the powder or the powder particle.

In an embodiment, the screw member 114 may be configured so that a sum of a length of the conveying zone A1 (length in the X-direction) and a length of the kneading zone A2 (length in the X-direction) is greater than or equal to 1, 100 mm and less than or equal to 1, 300 mm. In this case, the length of the conveying zone A1 and the length of the kneading zone A2 may be a length of the screw member 114 in the longitudinal direction (X-direction).

Accordingly, a sufficient kneading zone A2 may be secured, and the degree of fibrillation of the binder may be sufficiently secured. This may contribute to increased tensile strength of the electrode sheet. The degree of fibrillation may be an index of the degree to which the structure of the mixed powder 2 or the kneading powder 3 is formed into the fibrillation. In other words, the degree of fibrillation may be an index of the degree of fibrous properties of the material, or an index indicating how many portions arranged in the form of long and thin fibers are included.

When the sum of the length of the conveying zone A1 (length in the X-direction) and the length of the kneading zone A2 (length in the X-direction) is less than 1100 mm, dispersion and fibrillation effects may be reduced, and when the sum thereof is more than 1300 mm, production efficiency may be reduced due to overload.

In an embodiment, a total length of the screw member 114 may exceed the sum of the length of the conveying zone A1 and the length of the kneading zone A2. Among the length of the screw member 114, a length exceeding the sum of the length of the conveying zone A1 and the length of the kneading zone A2 may be utilized to include a drive shaft 114a, a rotating portion 118, and the like. Furthermore, a diameter D or a width of the screw member 114 may be 20 mm or more and 40 mm or less. In this case, the diameter D or the width of the screw member 114 may have the same value as a first diameter D1, which is a maximum width or a maximum diameter of the conveying disk member 115, described below.

The diameter D of the screw member 114 may affect the production capacity of the apparatus. When the diameter D or the width of the screw member 114 is 20 mm or more and 40 mm or less, a pilot scale of a production process may be achieved at 60 kg or more and 100 kg or less per hour.

FIG. 5 is a schematic perspective view of a conveying disk member 115 according to an embodiment of the present disclosure. FIG. 5 illustrates a single conveying disk member 115.

As illustrated in FIGS. 4 and 5, the conveying disk member 115 may be provided in plural and the plurality of conveying disk members 115 may be connected to form a conveying zone A1. A zone in which the plurality of conveying disk members 115 are arranged continuously in the longitudinal direction (X-direction) of the screw member 114 may be the conveying zone A1. The screw member 114 may include a single conveying zone A1 or a plurality of conveying zones A1.

The conveying disk member 115 may include a first coupling hole 115b. The screw member 114 may be inserted into the first coupling hole 115b. For example, the first coupling hole 115b may be provided with an uneven portion. In this case, an outer surface of the screw member 114 may also be provided with another uneven portion corresponding to the uneven portion provided in the first coupling hole 115b.

Alternatively, a gear member, or the like, having another uneven portion corresponding to the uneven portion provided in the first coupling hole 115b may be disposed between the outer surface of the screw member 114 and an inner surface of the conveying disk member 115. Accordingly, the conveying disk member 115 may be firmly secured to the screw member 114, and the rotation of the screw member 114 may be easily transmitted to the conveying disk member 115. Accordingly, the conveying disk member 115 may easily rotate together with the screw member 114.

In an embodiment, a diameter of the screw member 114 in the conveying zone A1 may refer to the first diameter D1, which is an outer diameter of the conveying disk member 115. The first diameter D1 may be a maximum diameter or a maximum width of the conveying disk member 115. When the screw member 114 is inserted into the first coupling hole 115b, the diameter D of the screw member 114 in the conveying zone A1 may refer to the first diameter D1, which is the outer diameter of the conveying disk member 115.

In an embodiment, at least one of the plurality of conveying disk members 115 may include a spiral edge 115a on an outer surface thereof. The conveying disk member 115 may have a pitch P, which is a distance between one edge 115a and another edge 115a adjacent to the one edge 115a. A space between the edges 115a may be a recessed space. The edge 115a may be spaced apart from an inner surface of the housing 111.

In an embodiment, the pitch P may be a value greater than or equal to 5 mm and less than or equal to 25 mm. For example, the pitch P may be 10 mm. For another example, the pitch P may be 20 mm.

In an embodiment, the first diameter D1 may be a maximum width or a maximum diameter of the conveying disk member 115 on the edge, in the cross-sectional shape of the conveying disk member 115.

For example, the edge 115a may have the shape of a wing, a blade, or other blade. The edge 115a may easily transport an electrode mixture. The edge 115a may be formed on the conveying disk member 115 so that, when the conveying disk member 115 rotates, the electrode mixture may be moved in the +X-direction or in a direction oriented toward the kneading zone A2.

The edge 115a may be spirally wound around the outer surface of the conveying disk member 115 or may spirally surround the outer surface of the conveying disk member 115.

A length of the screw member 114 of the conveying disk member 115 in the longitudinal direction (X-direction) may be a first unit length L1.

A length of the screw member 114 in the conveying zone A1 in the longitudinal direction (X-direction) may be a product of the first unit length L1 and the number of conveying disk members 115 present in the conveying zone A1. The length of the screw member 114 in the longitudinal direction (X-direction) of the conveying zone A1 may be calculated according to [Equation 1] below.

$$Length of the conveying zone A 1 = First unit length L 1 \times Number of conveying disk members 115 present in the conveying zone A 1 \qquad [ Equation 1 ]$$

The conveying zone A1 may face the inlet 113 and the conveying zone A1 may be disposed directly below the inlet 113. Accordingly, the mixed powder 2 falling from the inlet 113 may be supplied to the conveying zone A1. Accordingly, the mixed powder 2 may be prevented from flowing backwards in the mixing space 112 or the inlet 113, and the mixed powder 2 may be easily supplied to the kneading zone A2.

FIG. 6 is a schematic perspective view of a disk kneading member 116 according to an embodiment of the present disclosure. FIG. 6 illustrates a single disk kneading member 116.

As illustrated in FIGS. 4 and 6, in an embodiment of the present disclosure, the disk kneading member 116 may include a plurality of unit disk kneading members 116b. For example, the single disk kneading member 116 may be comprised of five unit disk kneading members 116b. However, the number of unit disk kneading members 116b included in the disk kneading member 116 is not limited by the present disclosure.

In an embodiment, the plurality of unit disk kneading members 116b may be disposed in close contact with each other or may be spaced apart from each other by a predetermined distance. This may be appropriately determined depending on the characteristics of the kneading powder or the mixed powder.

In an embodiment, at least one of the plurality of unit disk kneading members 116b may be oval. For example, one unit disk kneading member 116b may be oval. Alternatively, all of the plurality of unit disk kneading members 116b may be oval.

In the single disk kneading member 116, the plurality of unit disk kneading members 116b may be disposed adjacently to each other. The unit disk kneading members 116b adjacent to each other may be in contact with each other or may be spaced apart from each other by a small distance.

Each of the plurality of unit disk kneading members 116b may include a second coupling hole. A screw member 114 may be inserted into the second coupling hole. A length of the single disk kneading member 116 in the longitudinal direction (X-direction) of the screw member 114 may be a second unit length L2. The second unit length L2 may be calculated as a product of a length 117a of a single disk kneading member 116b and the number of unit disk kneading members 116b.

In the single disk kneading member 116, a plurality of unit disk kneading members 116b may be disposed to be offset from each other. For example, the plurality of unit disk kneading members 116b may be disposed to be offset from each other in a circumferential direction or a perimeter direction of the screw member 114. When the screw member 114 rotates, the plurality of unit disk kneading members 116b may rotate while being offset from each other.

The length of the screw member 114 in the longitudinal direction (X-direction) of the kneading zone A2 may be a product of the length 117a of the one unit disk kneading member 116b and the number of unit disk kneading members 116b present in the kneading zone A2. The length of the screw member 114 in the longitudinal direction (X-direction) of the kneading zone A2 may be calculated according to [Equation 2] below.

$$Length of the kneading zone A 2 = First unit length L 1 of conveying disk member 115 present in the kneading zone A 2 \times Number of conveying disk members 115 present in the kneading zone A 2 + Length 117 a of the unit disk kneading member 116 b present in the kneading zone A 2 \times Number of unit disk kneading members 116 b present in the kneading zone A 2 \qquad [ Equation 2 ]$$

A diameter of the screw member 114 in the kneading zone A2 may also be the first diameter D1 of the conveying disk member 115. In an embodiment, when the screw member 114 is inserted into a second coupling hole 116a, the diameter D of the screw member 114 in the kneading zone A2 may refer to a width W of the unit disk kneading member 116b. In this case, the width W of the unit disk kneading member 116b may be a maximum width of the unit disk kneading member 116b.

In an embodiment, the second coupling hole 116a may also be provided with an uneven portion. In this case, another uneven portion corresponding to the uneven portion formed in the second coupling hole 116a may be provided on the outer diameter of the screw member 114. Alternatively, a gear member having gear teeth may be further provided between the second coupling hole 116a and the screw member 114. Accordingly, the coupling between the disk kneading member 116 and the screw member 114 may be firmly maintained, and the rotation of the screw member 114 may be easily transmitted to the disk kneading member 116.

In an embodiment, the length 117a of the unit disk kneading member 116b in the longitudinal direction (X-direction) of the screw member 114 may be 3 mm or more and 9 mm or less. For example, the length 117a of at least one unit disk kneading member 116b, among the plurality of unit disk kneading members 116b, may be 3 mm or greater and 9 mm or less.

When the length 117a of the unit disk kneading member 116b is less than 3 mm, the kneading effect may be reduced to make fibrillation difficult, and when the length 117a exceeds 9 mm, a torque may increase excessively to reduce productivity.

In an embodiment, the length 117a of the unit disk kneading member 116b in the longitudinal direction (X-direction) of the screw member 114 may be 7 mm.

As illustrated in FIGS. 4 to 6, in an embodiment of the present disclosure, the screw member 114 may have a constant L/D value. In this case, the L/D value may be calculated using [Equation 3] below.

$$L / D = \frac{( length of the conveying zone A 1 + length of the kneading zone A 2 )}{first diameter D 1 of the disk conveying member 115} \qquad [ Equation 3 ]$$

As illustrated above, the L/D value may be expressed as (length of the conveying zone A1+length of the kneading zone A2)/(first diameter D1 of the conveying disk member 115. In this case, the first diameter D1 of the conveying disk member 115 may be 20 mm or more and 40 mm or less.

When the L/D value increases relatively, the mixed powder 2 may remain in the mixing space 112 for a relatively long time while being subjected to relatively high pressure. Accordingly, the kneading powder 3 mixed by the screw member 114 having a relatively high L/D value may progress relatively more in fibrillation, and the electrode sheet manufactured from the kneading powder 3 may have a relatively increased tensile strength.

On the other hand, when the L/D value decreases relatively, the mixed powder 2 may remain in the mixing space 112 for a relatively short time while being subjected to relatively low pressure. Accordingly, the kneading powder 3 mixed by the screw member 114 having a relatively low L/D value may progress relatively less in fibrillation, and the electrode sheet manufactured with the kneading powder 3 may have a relatively reduced tensile strength.

In an embodiment, a length 114b of the screw member 114 or a sum of the length of the conveying zone A1 and the length of the kneading zone A2 may be 1100 mm or more and 1300 mm or less.

Furthermore, in an embodiment, the length of the conveying zone A1 may be 500 mm or more and 900 mm or less, and the length of the kneading zone A2 may be 300 mm or more and 700 mm or less. In this case, the length of the conveying zone A1 and the length of the kneading zone A2 may be selected in a range in which the sum of the length 114b of the screw member 114 or the length of the conveying zone A1 and the length of the kneading zone A2 is 1100 mm or more and 1300 mm or less.

In an embodiment, the L/D value may be 27.5 or more and 65 or less. Accordingly, an electrode sheet having an appropriate tensile strength may be manufactured while preventing overload of the apparatus.

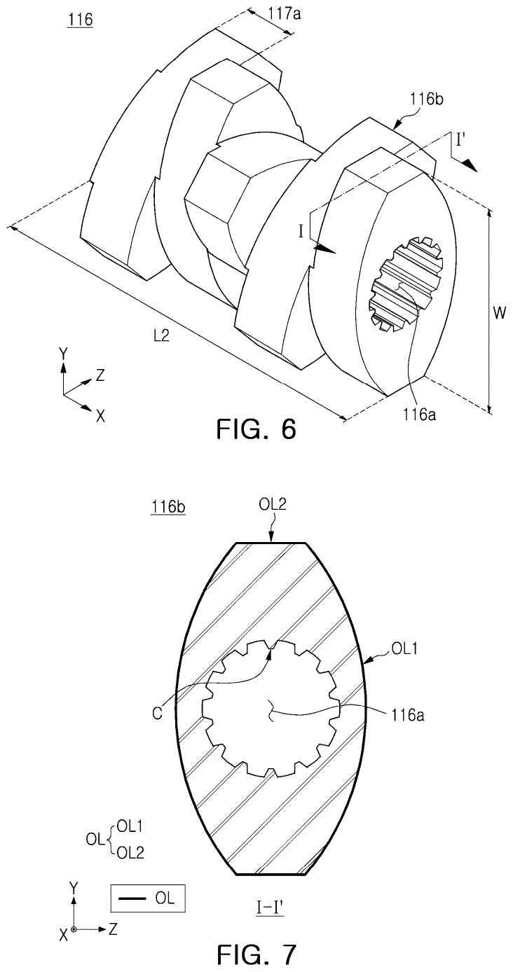

FIG. 7 schematically illustrates a cross-section taken along line I-I′ of FIG. 6.

As illustrated in FIGS. 4, 6 and 7, a cross-sectional shape of the unit disk kneading member 116b may include an ellipse. For example, in the thickness-wise cross-section (Y-Z plane) of the screw member 114, an outline line OL of the unit disk kneading member 116b may be a portion of the outline of the ellipse. Alternatively, the outline line OL of the unit disk kneading member 116b may include a curve OL1 forming an ellipse and a straight line OL2 connected to the curve OL1.

Furthermore, as described above, the unit disk kneading member 116b may include a second coupling hole 116a into which the screw member 114 is inserted, and an uneven portion C may be provided in the second coupling hole 116a.

As illustrated in FIGS. 4 to 7, a ratio of the sum of the length of the conveying zone A1 and the length of the kneading zone A2 to a total sum of the lengths 117a of the unit disk kneading members 116b present in the kneading zone A2 may be expressed as a kneading ratio. For example, the second unit length L2 of the single disk kneading member 116 may be expressed as the product of the length 117a of the single unit disk kneading member 116b constituting the single disk kneading member 116 and the number of unit disk kneading members 116b constituting the single disk kneading member 116. Accordingly, the sum of the lengths 117a of the unit disk kneading members 116b present in the kneading zone A2 may also be expressed as the product of the second unit length L2 and the number of disk kneading members 116 present in the kneading zone A2.

The kneading ratio may be calculated according to [Equation 4] below.

$$Kneading Ratio = \frac{Second unit length L 2 \times Number of disk kneading members 116}{( Length of conveying zone A 1 + Length of kneading zone A 2 )} or , \qquad [ Equation 4 ]$$

$$Kneading Ratio = \frac{Length 117 a of unit disk kneading members 116 b \times Number of unit disk kneading members 116 b}{( Length of conveying zone A 1 + Length of kneading zone A 2 )}$$

As illustrated above, the kneading ratio may be expressed as (second unit length L2 X number of disk kneading members 116)/((length of conveying zone A1+length of kneading zone A2) or (length of unit disk kneading member 116b 117a X number of unit disk kneading members 116b)/(length of conveying zone A1+length of kneading zone A2). When the kneading ratio is low, the stirring efficiency of the electrode mixture may be decreased. Accordingly, while increasing the kneading ratio, it may be necessary to suppress an excessive increase in force for rotating the screw member 114, and the Kneading Ratio may be set within a range satisfying this condition.

In an embodiment, the kneading ratio may have a value of 30% or more and 50% or less. Accordingly, it may be possible to increase the stirring efficiency of the electrode mixture may be increased, and to suppress an excessive increase in the force for rotating the screw member 114.

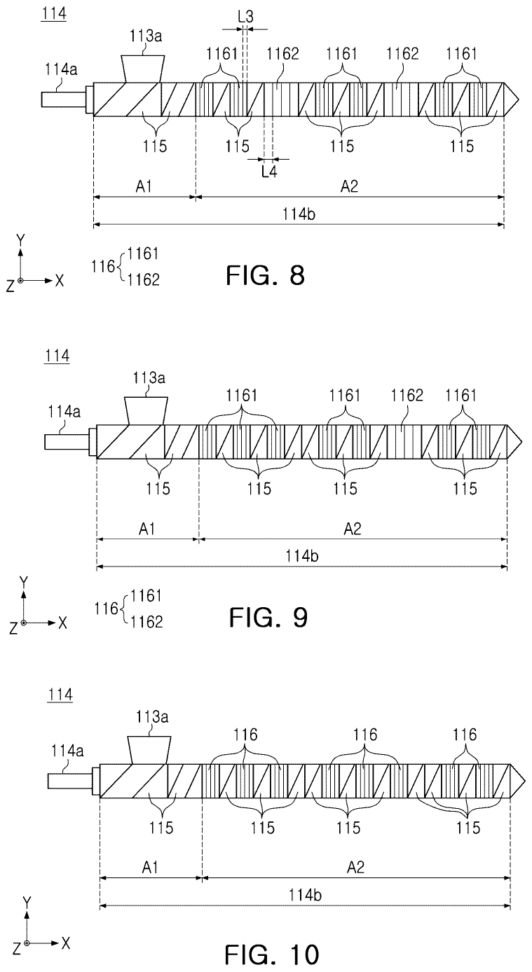

FIG. 8 schematically illustrates a screw member 114 according to an embodiment of the present disclosure.

As illustrated in FIG. 8, in an embodiment of the present disclosure, the length 114b of the screw member 114 may be the sum of the length of the conveying zone A1 and the length of the kneading zone A2.

At least one conveying disk member 115 may be provided in the conveying zone A1. For example, a plurality of conveying disk members 115 may be provided in the conveying zone A1.

In the kneading zone A2, the disk kneading members 116 and the conveying disk members 115 may be alternately disposed. For example, at least one disk kneading member 116 may be provided at a tip (or a leading end) of the kneading zone A2 or at a tip in the −X-direction from the kneading zone A2.

Additionally, at least one conveying disk member 115 may be disposed in a rear end in the +X-direction in the kneading zone A2. Accordingly, the mixed powder 2 or the kneading powder 3 in which stirring is completed may be easily discharged to the outside of the screw member 114.

At least one conveying disk member 115 may be interposed between members among the plurality of disk kneading members 116. Accordingly, the electrode mixture may be stirred while being conveyed in the longitudinal direction of the screw member 114.

The kneading ratio may be expressed as a ratio of a length occupied by the disk kneading member 116 in the length 114b of the screw member 114. For example, when the disk kneading member 116 is provided in plural, a length occupied by the disk kneading member 116 may be expressed as the product of the length of a single disk kneading member 116 and the number of disk kneading members 116.

For example, when the single disk kneading member 116 includes a plurality of unit disk kneading members 116b, the kneading ratio may be expressed as a ratio of a length of the plurality of unit disk kneading members 116b in the length 114b of the screw member 114. In this case, the length of the plurality of unit disk kneading members 116b may be expressed as the product of the length 117a of the single unit disk kneading member 116b and the number of unit disk kneading members 116b.

According to the screw member 114 illustrated in FIG. 8, the productivity of the mixed powder 2 or the kneading powder 3 may be improved, and the degree of fibrillation of the mixed powder 2 or the kneading powder 3 may be increased.

As illustrated in FIGS. 6 and 8, in an embodiment, the disk kneading member 116 disposed in the kneading zone A2 may include a plurality of unit disk kneading members 116b having different lengths 117a.

In an embodiment, the disk kneading member 116 disposed in the kneading zone A2 may include at least one first disk kneading member 1161 and at least one second disk kneading member 1162. In this case, the conveying disk member 115 may be disposed between the disk kneading members 116. For example, the conveying disk member 115 may be disposed between the first disk kneading member 1161 and the second disk kneading member 1162.

In an embodiment, at least one first disk kneading member 1161 may include a plurality of first disk kneading members 1161, and at least one second disk kneading member 1162 may include a plurality of second disk kneading member 1162.

The first disk kneading member 1161, the conveying disk member 115, and the second disk kneading member 1162 may be alternately disposed in the longitudinal direction (X-direction) of the screw member 114. For example, a plurality of first disk kneading members 1161 and a plurality of second disk kneading members 1162 may be disposed in the kneading zone A2. In this case, the conveying disk member 115 may be disposed in each space between the first disk kneading members 1161 and the second disk kneading members 1162. Accordingly, the conveying efficiency and mixing efficiency of the mixed powder 2 and/or the kneading powder 3 may be improved.

In an embodiment, the length 117a of at least one unit disk kneading member 116b included in the first disk kneading member 1161 may have a first length L3, and the length 117a of at least one unit disk kneading member 116b included in the second disk kneading member 1162 may have a second length L5. Furthermore, in an embodiment, the length 117a of the unit disk kneading member 116b included in the first disk kneading member 1161 may be shorter than the length 117a of the unit disk kneading member 116b included in the second disk kneading member 1162.

For example, the first length L3, which is the length 117a of the unit disk kneading member 116b included in the first disk kneading member 1161, may be 3 mm or more and 5 mm or less, and the second length L4, which is the length 117a of the unit disk kneading member 116b included in the disk kneading member 1162, may be 7 mm or more and 9 mm or less.

For example, the first length L3 may be 4 mm, and the second length L4 may be 8 mm.

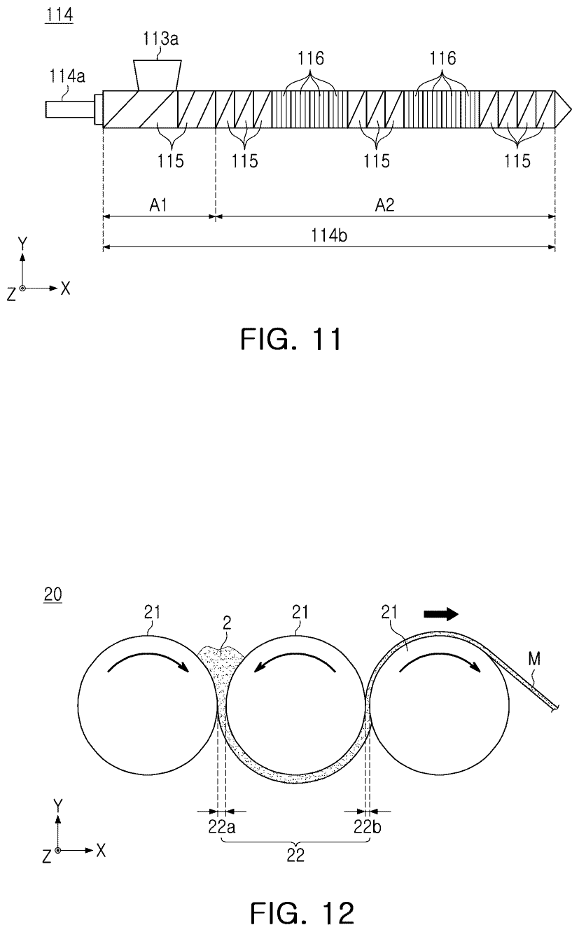

FIG. 9 schematically illustrates a screw member 114 according to another embodiment of the present disclosure, FIG. 10 schematically illustrates a screw member 114 according to another embodiment of the present disclosure, and FIG. 11 schematically illustrates a screw member 114 according to another embodiment of the present disclosure.

As illustrated in FIGS. 9 and 11, the screw member 114 may have various kneading ratios depending on the characteristics of the mixed powder 2. By implementing a kneading ratio appropriate to the characteristics of the mixed powder 2, the stirring efficiency may be improved and a torque increase may be suppressed.

Meanwhile, according to the screw member 114 illustrated in FIG. 9, the productivity of the kneading powder 3 may be improved and the degree of fibrillation of the kneading powder 3 may be reduced.

According to the screw member 114 illustrated in FIG. 10, the productivity of the kneading powder 3 may be improved and the degree of fibrillation of the kneading powder 3 may be reduced as compared to the screw member 114 illustrated in FIG. 9.

FIG. 12 schematically illustrates a press unit 20 according to an embodiment of the present disclosure.

As illustrated in FIG. 12, in an embodiment of the present disclosure, the press unit 20 may include a plurality of press roll members 21 spaced apart from each other to form a press gap 22 and to rotate.

The plurality of press roll members 21 may be connected or joined to a screw member 114. The plurality of press roll members 21 may be provided to receive the kneading powder 3 in which stirring is completed, from the screw member 114.

The kneading powder 3 may be input into the press gap 22. For this purpose, a separate conveyor belt, a transport device, and an in putting device may be additionally provided.

In an embodiment, the press gap 22 may include a first press gap 22a and a second press gap 22b. The kneading powder 3 may be initially supplied to the first press gap 22a. The kneading powder 3 may be supplied from the first press gap 22a to the second press gap 22b by the rotation of multiple press roll members 21.

In an embodiment, a width of the first press gap 22a may be wider than a width of the second press gap 22b.

The kneading powder 3 passing through the second press gap 22b may be compressed into a sheet shape and manufactured into an electrode sheet (M).

However, the number and width of the press gaps 22 are not limited by the present disclosure and may be changed depending on the characteristics of the kneading powder 3, the manufacturing specifications of an electrode sheet (M), and the like.

Furthermore, in an embodiment, as illustrated in FIGS. 5 and 6, the width W of the disk kneading member 116 may be greater than or equal to 20 mm and less than or equal to 40 mm, and the first diameter D1, which is the outer diameter of the conveying disk member 115, may also be greater than or equal to 20 mm and less than or equal to 40 mm.

Meanwhile, for example, the diameter D of the screw member 114 may be the first diameter D1, which is a maximum diameter of the conveying disk member 115.

In some cases, the diameter D of the screw member 114, a maximum value among the width W of the disk kneading member 116, and the first diameter D1 of the conveying disk member 115 may be the same value.

Meanwhile, as another aspect, the present disclosure provides a method for manufacturing an electrode sheet.

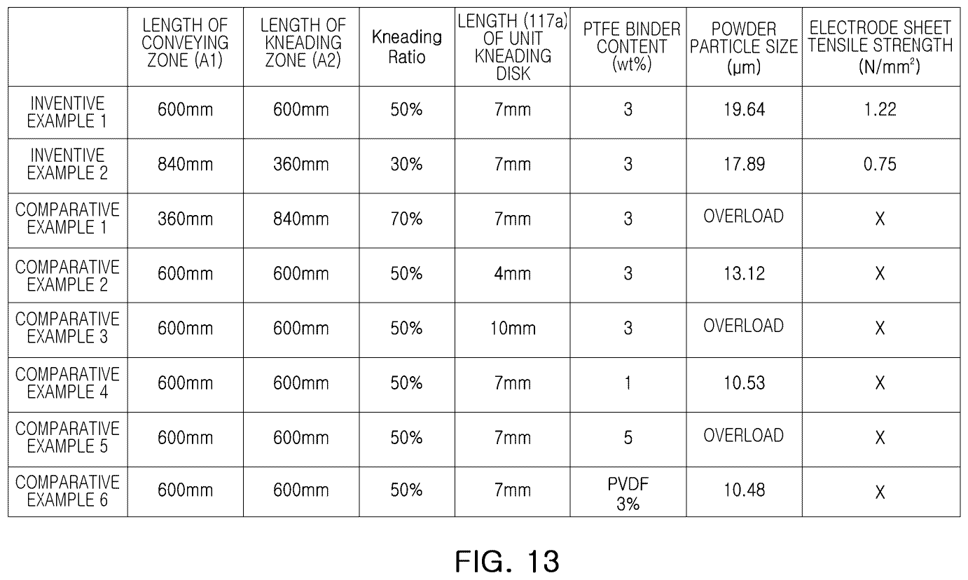

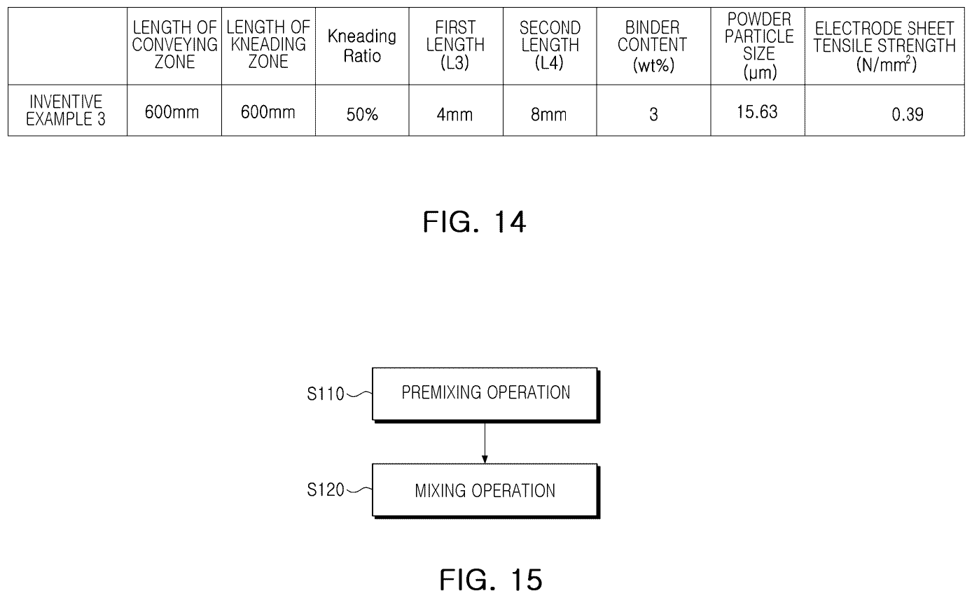

FIG. 13 is a table comparing the tensile strength of electrode sheet manufactured using an electrode sheet manufacturing apparatus and/or method according to inventive examples of the present disclosure with the tensile strength of an electrode sheet manufactured according to comparative examples, FIG. 14 is a table illustrating the tensile strength of an electrode sheet manufactured using an electrode sheet manufacturing apparatus and/or method according to another embodiment of the present disclosure, and FIG. 15 schematically illustrates an electrode sheet manufacturing method according to an embodiment of the present disclosure.

As illustrated in FIGS. 4 to 15, the electrode sheet manufacturing method according to an embodiment of the present disclosure is a method of manufacturing an electrode sheet using the above-described electrode sheet manufacturing apparatus may include a premixing operation (S110) of mixing a powder particle-type electrode active material, a conductive material, and a binder to manufacture a mixed powder, and a mixing operation (S120) of stirring the mixed powder with the screw member 114 to manufacture a kneading powder.

In an embodiment, the binder is polytetrafluoroethylene (PTFE) and may have a weight percentage of 2 wt % or more and 4 wt % or less relative to the weight of the mixed powder.

In this case, a weight percentage (wt %) may be relative to the weight of the mixed powder 2. This prevents the tensile strength of the electrode sheet from deteriorating and improves productivity.

For example, when the weight percentage of the binder is less than 2, the tensile strength of the electrode sheet may deteriorate, and when the weight percentage thereof exceeds 4, torque may increase excessively, resulting in reducing productivity.

Furthermore, in an embodiment, the electrode active material may be present in a weight percentage of 96 wt % or more and 98 wt % or less.

Furthermore, a conductive material may be present in a weight percentage of 0.3 wt % or more and 0.6 wt % or less. The properties of the electrode active material may be determined by the content of the binder and conductive material, and when the content of the conductive material is less than 0.3 wt %, electrical conductivity may decrease to reduce the efficiency of battery cells, and when the content of the conductive material exceeds 0.6 wt %, a proportion of electrode active material in the mixed powder may be reduced.

The mixed powder described above may suppress an excessive increase in a torque of the screw member 114 of the electrode sheet manufacturing apparatus, and may improve the quality of the mixed powder for manufacturing a dry electrode sheet.

Furthermore, an appropriate degree of fibrillation in the kneading powder may be implemented. This thus may contribute to improved electrode sheet quality.

Meanwhile, as illustrated in FIGS. 4, 6, 10, 11 and 13, in Inventive Example 1, the length of the conveying zone A1 may be 600 mm, the length of the kneading zone A2 may be 600 mm, and the kneading ratio may be 50%. In this case, the length 117a of the unit disk kneading member 116b may be 7 mm, and the PTFE binder weight may be 3 wt % (weight percentage) relative to the weight of the mixed powder.

In this case, an average size or an average diameter of powder particles constituting the mixed powder may be 19.64 μm. The tensile strength of the electrode sheet manufactured under the above-described conditions is 1.22 N/mm². The tensile strength of the electrode sheet may be measured by pulling both ends of a specimen having a width of 10 mm and a length of 100 mm at a constant speed using a Universal Testing Machine (UTM).

Furthermore, in Inventive Example 2, a length of the conveying zone A1 may be 840 mm, a length of the kneading zone A2 may be 360 mm, and a kneading ratio may be 30%. In this case, the length 117a of the unit disk kneading member 116b may be 7 mm, and the PTFE binder weight may be 3 wt % (weight percentage) relative to the weight of the mixed powder 2. In this case, an average size or an average diameter of powder particles constituting the mixed powder 2 may be 17.89 μm. The tensile strength of the electrode sheet manufactured under the above-described conditions is 0.75 N/mm².

Conversely, under the conditions of Comparative Examples 1 to 6, the rotating portion 118 was overloaded, or the tensile strength of the electrode sheet did not meet the standard. Specifically, in Comparative Example 6, polyvinylidene fluoride (PVDF) was 3%, and it was impossible to perform the fibrillation on the mixed powder, so that it was impossible to manufacture the kneading powder.

Accordingly, according to the electrode sheet manufacturing apparatus 1 and the mixed powder 2 according to at least one of Inventive Example 1 or Inventive Example 2 described above, overloading of the screw member 114 or the rotating portion 118 may be prevented, while improving the quality of the electrode sheet, the quality of the mixed powder, and the quality of the kneading powder.

Furthermore, the mixed powder according to another embodiment of the present disclosure may include an electrode active material having electrical conductivity, a binder, and a conductive material. In this case, the binder may be polytetrafluoroethylene (PTFE). The binder may be present in an amount of 2 wt % or more and 4 wt % or less, the electrode active material may be present in an amount of 96 wt % or more and 98 wt % or less, and the conductive material may be present in an amount of 0.3 wt % or more and 0.6 wt % or more.

Meanwhile, as illustrated in FIGS. 6, 8, 9 and 14, according to another embodiment of the present disclosure, the length 117a of the unit disk kneading member 116b belonging to the first disk kneading member 1161 and the length 117a of the unit disk kneading member 116b belonging to the second disk kneading member 1162 may be different from each other.

In Inventive Example 3 illustrated in FIG. 14, the first length L3, which is the length 117a of the unit disk kneading member 116b belonging to the first disk kneading member 1161, may be 4 mm, and the second length L4, which is the length 117a of the unit disk kneading member 116b belonging to the second disk kneading member 1162, may be 8 mm.

In this case, the length of the conveying zone A1 may be 600 mm, the length of the kneading zone A2 may be 600 mm, and the kneading ratio may be 50%. Furthermore, the PTFE binder weight may be 3 wt % (weight percentage), and an average size or a diameter of powder particles constituting the mixed powder may be 15.63 μm. The tensile strength of the electrode sheet manufactured under the above-described conditions is 0.39 N/mm². As described above, the tensile strength of the electrode sheet may be measured by pulling both ends of a specimen having a width of 10 mm and a length of 100 mm at a constant speed using a Universal Testing Machine (UTM).

The contents described above are merely an example of applying the principles of the present disclosure. Other components may be incorporated or substituted without departing from the scope of the present disclosure. Furthermore, the present disclosure may be implemented by deleting or modifying some of the components in the above-described embodiments. Furthermore, the present disclosure may be implemented in each embodiment alone or in combination with other embodiments.

What is claimed is:

1. An electrode sheet manufacturing apparatus, comprising:
a mixing unit mixing powder particle-type mixed powder including an electrode active material to form kneading powder; and
a press unit connected to the mixing unit and pressurizing the kneading powder to form an electrode sheet,
wherein the mixing unit includes:
a housing including a mixing space; and
a screw member disposed in the mixing space and including a plurality of conveying disk members and a plurality of disk kneading members provided with a plurality of unit disk kneading members, and
a kneading ratio between a length of the screw member and a length of the plurality of unit disk kneading members is 30% or more and 50% or less.

2. The electrode sheet manufacturing apparatus of claim 1, wherein the screw member includes:
a conveying zone in which the plurality of conveying disk members are arranged in a longitudinal direction of the screw member; and
a kneading zone which is adjacent to the conveying zone, and in which the conveying disk member and the disk kneading member are alternately disposed,
wherein a length of the screw member is a sum of a length of the conveying zone and the kneading zone.

3. The electrode sheet manufacturing apparatus of claim 2, wherein in the screw member, a ratio of the sum of the length of the conveying zone and the length of the kneading zone to a diameter of the conveying disk member is 27.5 or more and 65 or less.

4. The electrode sheet manufacturing apparatus of claim 1, wherein a length of at least one of the plurality of unit disk kneading members is 3 mm or more and 9 mm or less.

5. The electrode sheet manufacturing apparatus of claim 4, wherein the plurality of disk kneading members include:
a first disk kneading member in which a length of the at least one unit disk kneading member has a first length; and
a second disk kneading member in which a length of the at least one unit disk kneading member has a second length.

6. The electrode sheet manufacturing apparatus of claim 5, wherein the first length is 3 mm or more and 5 mm or less, and
the second length is 7 mm or more and 9 mm or less.

7. The electrode sheet manufacturing apparatus of claim 1, wherein at least one conveying disk member of the plurality of conveying disk members includes a spiral edge on an outer surface thereof.

8. The electrode sheet manufacturing apparatus of claim 1, wherein at least one unit disk kneading member of the plurality of unit disk kneading members is oval.

9. The electrode sheet manufacturing apparatus of claim 1, wherein the press unit includes:
a plurality of press roll members spaced apart from each other to form a pressurizing gap and configured to rotate.

10. The electrode sheet manufacturing apparatus of claim 1, further comprising:
a rotating portion rotating the screw member.

11. An electrode sheet manufacturing method, the method of manufacturing an electrode sheet using an electrode sheet manufacturing apparatus of claim 1, comprising:
a premixing operation of mixing powder particle-type electrode active material, a conductive material, and a binder to manufacture mixed powder; and
a mixing operation of stirring the mixed powder with the screw member to manufacture kneading powder.

12. The electrode sheet manufacturing method of claim 11, wherein the electrode active material is 96 wt % or more and 98 wt % or less.

13. The electrode sheet manufacturing method of claim 11, wherein the binder is polytetrafluoroethylene (PTFE) and has a value of 2 wt % or more and 4 wt % or less relative to a weight of the mixed powder.

14. The electrode sheet manufacturing method of claim 11, wherein the conductive material is 0.3 wt % or more and 0.6 wt % or less.
